(19) United States
(12) Patent Application Publication
(10) Pub. No.: US 2015/0332292 A1
(43) Pub. Date: Nov. 19, 2015

(54) SYSTEM AND METHOD FOR MONITORING MARKET INFORMATION FOR DEREGULATED UTILITIES BASED ON TRANSACTION DATA

(71) Applicant: MASTERCARD INTERNATIONAL INCORPOATED, Purchase, NY (US)

(72) Inventors: Kenny Unser, Fairfield, CT (US); Serge Bernard, Danbury, CT (US); Nikhil A. Malgatti, Stamford, CT (US)

(73) Assignee: MASTERCARD INTERNATIONAL INCORPOATED, Purchase, NY (US)

(21) Appl. No.: 14/276,505

(22) Filed: May 13, 2014

(51) Int. Cl. G06Q 30/02

(52) U.S. Cl. CPC G06Q 30/0202

(57) ABSTRACT

A system for determining market information of unregulated utility services comprises: a data storage device containing payment card transaction data of customers including customer information and information identifying a category of unregulated utility services; a filter configured to identify those transactions associated with the category of unregulated utility services from the payment card transaction data within a predetermined geographic region; a data storage device containing market or industry data related to the category of unregulated utility services; a processor; a memory storing program instructions, the processor being operative with the program instructions to: analyze the identified payment card transactions and the market or industry data related to the category of unregulated utility services; determine a score indicator representative of a given customer's probability of switching utility providers; compare the score indicator with a threshold value; and identifying those customers whose score indicator exceeds the threshold value.

### CROSS-REFERENCE TO RELATED APPLICATIONS

None.

### FIELD OF INVENTION

Embodiments relate to systems and methods to facilitate the determination and pricing associated with deregulated utilities and generating communications related to services associated therewith, based on payment card transactions.

### BACKGROUND

Merchants solicit business through various means in order to attempt to influence customers' buying decisions. Such means include but are not limited to direct targeting of consumers, indirect advertisements and discount offers, promotional strategies such as direct mail, telemarketing, direct response television advertising and online selling. Merchants may also solicit leads to new business through word of mouth and relationship building, by way of non-limiting example. However, it is often challenging for merchants such as deregulated (or “unregulated”) utility providers to determine preferred times for soliciting certain service activities associated with a particular product. For example, it may be difficult to determine customer sentiment in a geographic region with regard to choosing from a multitude of utility providers and the reasons for such sentiment.

Likewise, in a market where consumers have a choice over which utility service provider they are going to use, consumers increasingly look to available information sources when looking to establish utility service, or for switching utility providers. However, it is often difficult to navigate the available information, which may include marketing puffery as well as seasonal and regional variables, in order to make an informed decision. Alternative systems and methods are desired.

### SUMMARY

In embodiments, systems and computer-implemented methods provide consumers and/or merchants and/or businesses and third parties with enhanced data indicative of long-term utility cost and spending data using payment card transaction data. Embodiments of the disclosure also relate to systems and methods to facilitate the determination of market attributes relating to the selection of a lowest overall cost utility provider or marketing information relating to how a utility provider can compete in a particular region based on the present state of utility payment transactions in the region.

In one embodiment, a system for determining market information of unregulated utility services for purchase by a third party comprises one or more data storage devices containing payment card transaction data of a plurality of customers, wherein the payment card transaction data includes at least customer information and information identifying a category of unregulated utility services associated with the transaction data. A filter is configured to identify payment card transactions associated with the category of unregulated utility services from the payment card transaction data within a predetermined geographic region. One or more data storage devices contain at least one of market and industry data related to the category of unregulated utility services associated with the transaction data. A memory is in communication with one or more processors and stores program instructions, wherein the one or more processors are operative with the program instructions to: analyze the identified payment card transactions and the market or industry data related to the category of unregulated utility services to determine a score indicator associated with at least one parameter value representative of a given customer's probability of switching providers within the category of unregulated utility services; compare the score indicator with a threshold value; and generate an output identifying each given customer whose score indicator exceeds the threshold value.

In one embodiment, the market or industry data includes indicators of utility demand, utility pricing information, and supply estimations.

In one embodiment, the at least one parameter value comprises an average customer spend amount.

In one embodiment, the at least one parameter value further comprises an average customer switching provider frequency.

In one embodiment, the at least one parameter value comprises an average payment frequency.

In one embodiment, the calculation of the probability value includes comparing historical average spend amounts of the given customer with an aggregated customer profile average spend amount from historical averages of multiple customers.

In one embodiment, the calculation of the probability value further includes comparing historical average switching provider frequencies of the given customer with aggregated customer profile average switching provider frequencies from historical averages of multiple customers.

In one embodiment, the unregulated utility services comprises at least one of electric and natural gas suppliers, telephone, cable, satellite, high speed internet, fiber optic and DSL providers.

In one embodiment, a system for determining market information for consumers of unregulated utility services based on payment card transaction data, the system comprises: one or more data storage devices containing payment card transaction data of a plurality customers and merchants, the payment card transaction data including customer information, merchant information, and transaction amounts; one or more processors; a memory in communication with the one or more processors and storing program instructions, the one or more processors operative with the program instructions to: identify consumers of an unregulated utility service based on processing payment card transaction data of a plurality customers and merchants, the payment card transaction data including customer information, merchant information, and transaction amounts, the processing including statistical analysis of said payment card transaction data to identify relationships between different payment card transactions representing a correlation of a given particular service provider linked to said payment card transaction data; determine, based on said payment card transaction data of the plurality of customers and merchants, characteristic traits of said consumers for actions linked to said unregulated utility service, relating to utility payments for a given action associated with said unregulated utility service, to thereby provide profile data; select a particular characteristic trait identifiable from said payment card transaction data, and apply to it the determined profile data, along with one or more user selected data characteristics associated with a given action of said unregulated utility service, to thereby obtain data representative of market conditions for the given action of the unregulated utility service adjusted by said user selected data characteristics.

The one or more processors are configured to output an indication of a likelihood for the given action of the unregulated utility service.

The statistical analysis of the payment card transaction data comprises at least one of i) a trend analysis, (ii) a time series analysis, (iii) a regression analysis, (iv) a frequency distribution analysis, (v) and predictive modeling.

The profile data includes one or more customer profiles, merchant profiles, and transaction profiles.

A method for identifying at least one provider of an unregulated utility service based on payment card transaction data, the method comprising: identifying, by a processor, providers of an unregulated utility service based on processing payment card transaction data of a plurality customers and merchants, the payment card transaction data including customer information, merchant information, and transaction amounts, the processing including statistical analysis of the payment card transaction data to identify relationships between different payment card transactions representing a correlation of a given service provider and cost factors for providing a selected utility service; determining, by a processor, based on the payment card transaction data of the plurality of customers and merchants, characteristic utility payment traits of the customers for actions linked to receiving the selected utility service, to thereby provide profile data; selecting a particular utility service provider identifiable from the payment card transaction data, and applying to it the determined profile data, along with one or more user selected data characteristics for receiving the selected utility service, to thereby obtain data representative of an overall cost of receiving the selected utility service adjusted by the user selected data characteristics.

### BRIEF DESCRIPTION OF THE DRAWINGS

FIG. 1 illustrates a system architecture within which some embodiments may be implemented.

FIG. 2 is a functional block diagram of a managing computer system for a payment card service provider in accordance with an exemplary embodiment.

FIG. 3 illustrates a system for providing services related to a property based on transactions data in accordance with an exemplary embodiment.

FIG. 4 illustrates exemplary transaction record data useful in implementing aspects of the present system and method.

FIG. 5 illustrates an exemplary process flow for determining information based on transaction records and applying said determined information to a select profile for providing information about one or more actions of utility service providers associated with the profile.

FIG. 6 illustrates another exemplary process flow for determining information based on transaction records and applying said determined information to a select profile for providing information relating to one or more market characteristics of an unregulated utility marketplace associated with the profile.

FIG. 7 illustrates a system and process flow that uses payment card transaction data to determine the pricing employed by deregulated utilities in various geographies.

FIG. 8 illustrates an exemplary process flow whereby the system embodied in the present invention performs a transaction analysis of a select customer or merchant of a utility service to determine information concerning the utility service purchased as well as determine other purchasers of that type of serviceable property.

FIG. 9 illustrates a system and process flow for obtaining profile data to determine relational characteristics and traits associated with a selected utility market and determine consumer sentiment based on historical utility payment card transaction data.

FIG. 10 illustrates an exemplary process flow for determining a likelihood of consumer sentiment for changing servicer providers based on historical utility payment card transaction data.

### DETAILED DESCRIPTION

Disclosed herein are processor-executable methods, computing systems, and related processing for the administration, management and communication of data relating to the provision of unregulated utilities derived from payment card transaction data from customers and merchants. Transaction data comprising a multiplicity of payment card transactions records may include customer information, merchant information, and transaction amounts and are processed to identify consumers and providers of unregulated utilities. Transactions data may be stored in a data base (e.g. a relational data base) and analyzed to link relevant fields within various records to one another in order to determine and establish (e.g. cause and effect, associations and groupings) relationships and links between and among categories of services, customers, merchants, geographic regions, and the like.

Statistical analyses and techniques applied to the payment card transactions records to construct logic circuits for determining consumers of a given utility service. The system is configured to analyze the payment card transactions records to determine relationships, patterns, and trends between and among the various transaction records in order to predict future transactions and estimated times and frequencies associated with such transactions. Such statistical analyses may be targeted to particular subsets of the transactions data, including by way of non-limiting example, one or more particular geographic regions, business categories, customer categories, deregulated utility product or service types, and purchasing frequencies. The transaction records may be processed and segmented into various categories in order to determine purchasers of a given deregulated utility service, purchasing frequencies, and drivers or factors affecting the service or frequency of service, by way of non-limiting example. The Logic circuits are implemented to ascribe attributes or traits to consumers of an unregulated utility based on the payment card transaction data. Based on the payment card transaction data of the plurality of customers and merchants, characteristic traits of the consumers that relate to specific actions are linked to the provision of the unregulated utility, thereby relating overall long-term costs to other factors relating to providing and/or receiving unregulated utility services.

The analysis engine may utilize independent variables as well as dependent variables representative of one or more purchasing events, customer types or profiles, merchant types or profiles, purchase amounts, and purchasing frequencies, by way of example only. The analysis engine may use models such as regression analysis, correlation, analysis of variances, time series analysis, determination of frequency distributions, segmentation and clustering applied to the transactions data in order to determine and predict the effect particular categories of data have on other categories, and thereby determine drivers of particular actions or services associated with a serviceable property represented in the transactions data.

Selection by a consumer of a particular unregulated utility service provider identified from the payment card transaction data, and applying to the selection the determined profile data, along with one or more user selected data characteristics associated with a given decision for selecting a service provider, enables one to obtain data representative of overall market dynamics which may indicate the consumer sentiment behind a specific selection of an unregulated utility provider. In this manner, application of the logic developed using the above process enables customers, markets, and/or service providers to receive or deliver information and meaningful insight relating to various commercial and consumer related applications.

In accordance with an exemplary embodiment, the system and method described herein provide a framework to utilize payment card transactions to provide data representative of actions taken with respect to one or more unregulated utility providers identifiable from the payment card transaction data.

It is to be understood that a payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

A “payment card processing system” or “credit card processing network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

Determination of a merchant classification or category may be implemented using one or more indicia or merchant classification codes to identify or classify a business by the type of goods or services it provides. For example, ISO Standard Industrial Classification (“SIC”) codes may be represented as four digit numerical codes assigned by the U.S. government to business establishments to identify the primary business of the establishment. Similarly a “Merchant Category Code” or “MCC” is also a four-digit number assigned to a business by an entity that issues payment cards or by payment card transaction processors at the time the merchant is set up to accept a particular payment card. Such classification codes may be included in the payment card transactions records. The merchant category code or MCC may be used to classify the business by the type of goods or services it provides. For example, in the United States, the merchant category code can be used to determine if a payment needs to be reported to the IRS for tax purposes. In addition, merchant classification codes are used by card issuers to categorize, track or restrict certain types of purchases. Other codes may also be used including other publicly known codes or proprietary codes developed by a card issuer, such as NAICS or other industry codes, by way of non-limiting example.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

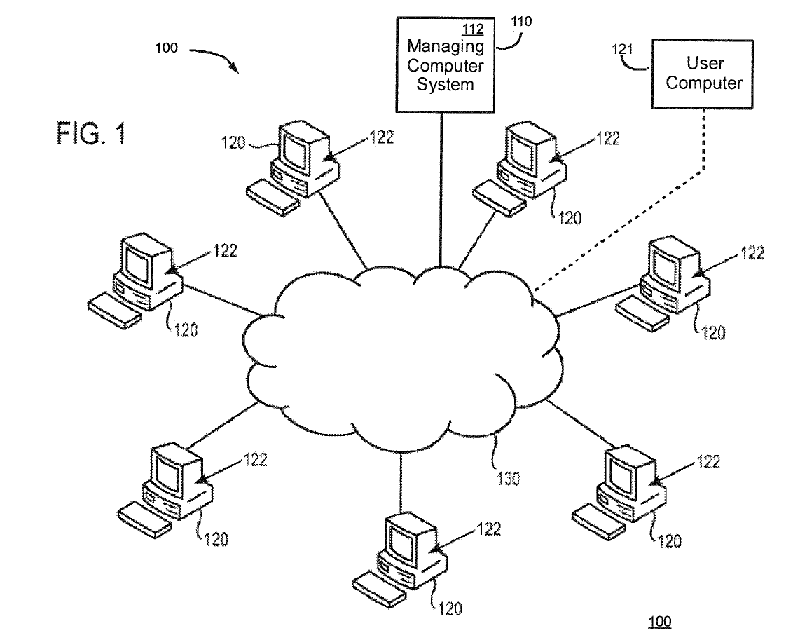

Referring now to FIG. 1, there is shown a high-level diagram illustrating an exemplary system for providing services based on payment card transactions data according to an embodiment of the disclosure. As shown in FIG. 1, the system 100 includes a managing computer system 110 that includes a data store or data warehouse for storing payment card transaction records associated with a payment card service provider 112. Each payment transaction performed by a transaction acquirer and/or merchant 122 having a corresponding merchant computer system 120 is transferred to the managing computer system 110 via a network 130 which connects the computer system 120 of the transaction acquirer or merchant 122 with the managing computer system 110 of the payment card service provider 112. Transactions performed between a customer or cardholder and a transaction acquirer or merchant 122 may comprise point of sale transactions, or electronic point of sale transactions performed via a customer or cardholder computer 121.

The network 130 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission.

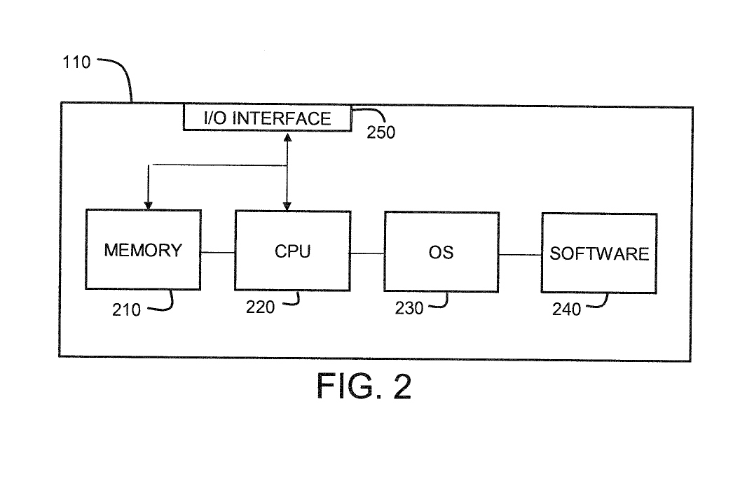

The managing computer system 110 for the payment card service provider 112 as shown in FIG. 2 includes at least one memory device 210 configured to store data that associates identifying information of individual customers, merchants, and transactions associated with payment card accounts. System 110 further includes a computer processor 220, and an operating system (OS) 230, which manages the computer hardware and provides common services for efficient execution of various logic circuitry including hardware, software and/or programs 240. The processor 220 (or CPU) carries out the instructions of a computer program, which operates and/or controls at least a portion of the functionality of the managing computer system 110. System 110 further includes device input/output interface 250 configured to receive and output network and transactions data and information to and/or from managing computer system 110 from and/or to peripheral devices and networks operatively coupled to the system. Such devices may include user terminals 121 and/or merchant terminals 120 including point of sale terminals, wireless networks and devices, mobile devices and client/server devices, and user interfaces communicatively coupled over one or more networks for interfacing with managing system 110. The I/O interface 250 may include a query interface configured to accept and parse user requests for information based on the payment card transactions data. In addition, the I/O interface may handle receipt of transactions data and perform transactions based processing in response to receipt of transactions data as a result of a particular purchase via a point of sale terminal, by way of non-limiting example only.

The at least one memory device 210 may be any form of data storage device including but not limited to electronic, magnetic, optical recording mechanisms, combinations thereof or any other form of memory device capable of storing data, which associates payment card transactions of a plurality of transaction acquirers and/or merchants. The computer processor or CPU 220 may be in the form of a stand-alone computer, a distributed computing system, a centralized computing system, a network server with communication modules and other processors, or nearly any other automated information processing system configured to receive data in the form of payment card transactions from transaction acquirers or merchants 122. The managing computer system 110 may be embodied as a data warehouse or repository for the bulk payment card transaction data of multiple customers and merchants. In addition, the computer system 120 or another computer system 121 (e.g. user computer of FIG. 1) connected to computer system 110 (via a network such as network 130) may be configured to request or query the managing computer system 110 in order to obtain and/or retrieve information relating to categories of customers, merchants, and services associated therewith, based on information provided via the computer system 120 or 121 and profiling of the transaction data contained in computer system 110 according to the particular query/request.

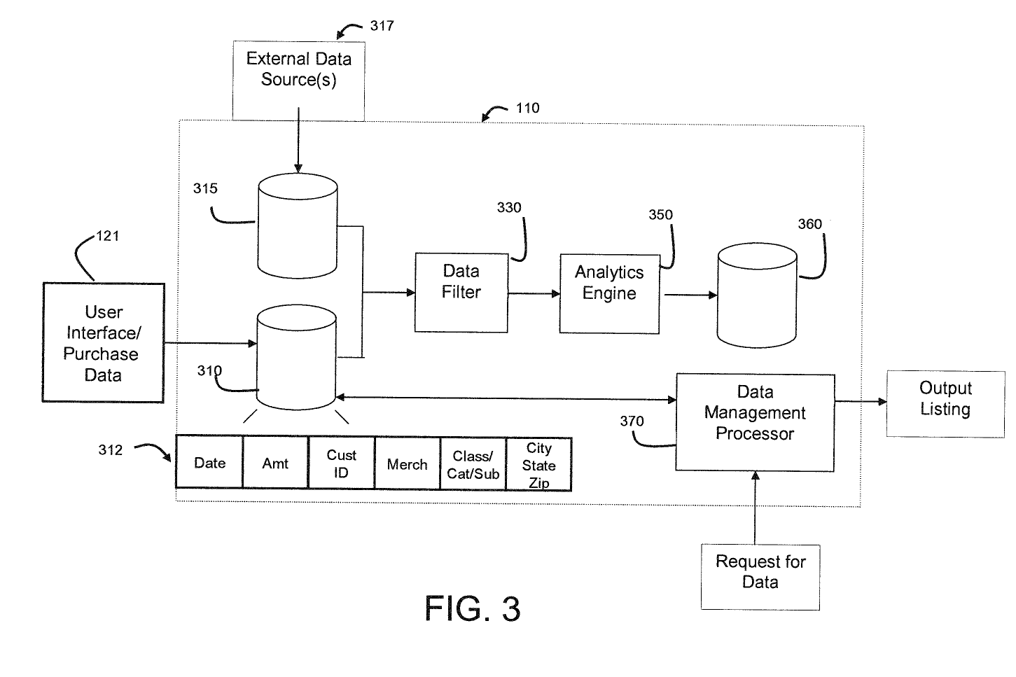

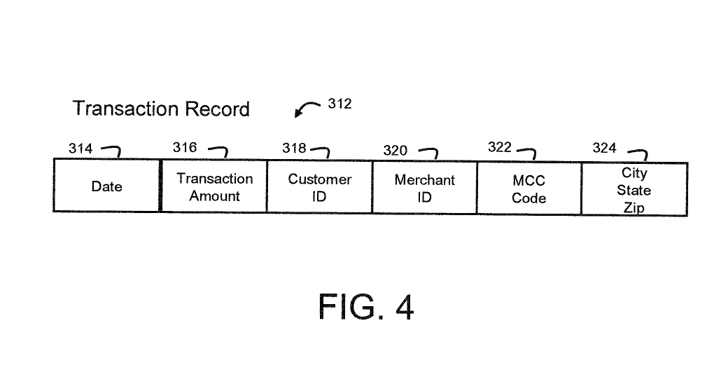

Referring now to FIG. 3, there is shown a system block diagram and operational flow for collecting, determining, and delivering information on utility services (e.g. unregulated or deregulated utility services) based on processing of payment card transaction data according to an embodiment of the present disclosure. Customer and merchant transaction data stored in managing computer system 110 is configured and processed to provide intelligent information and profiling data for categorizing customers and merchants within one or more market segments, geographic regions, and services. A database 310 containing a multiplicity of transaction data is included in managing computer system 110 (FIGS. 1 and 2). In one embodiment, database 310 comprises transaction data specifically associated with merchants and/or business classifications or categories of utilities, such as those based on MCC Codes (e.g. utilities—MCC Code 4900). This data may be generated from filtering generalized payment card transaction data. Payment card transactions records 312 may be obtained via various transaction mechanisms, such as credit and debit card transactions between customers and merchants (e.g. utility service providers) originating via a cardholder terminal or computer 121 (e.g. a personal computer). Payment card transaction records 312 may include transaction date 314 as well as customer information 316, merchant information 318 and transaction amount 320. Customer information 316 may further include customer account identifier (ID) and customer type, as provided in an exemplary transaction record illustrated in FIG. 4. This information may originate from, for example, passive means, such as ISO 8583 information from all payment card purchases. Additional information regarding the details of a cardholder's transaction history may be provided to the card network by, for example, clearing addenda received after purchases have been completed, and may further populate database 310.

The system further includes one or more market and industry databases, embodied herein as database 315. Database 315 includes utility-specific market data and industrial data. Market data may include, for example, indicators of utilities service demand, including pricing, sales volume, and an analysis of supply and demand for utility services (e.g. comparing cost of electricity over time intervals with that of other energy that may be supplied to a customer within a given region, or comparing average costs of energy utility suppliers of a given energy within a region, etc.). In one embodiment, the determined average may be calculated as the arithmetic average (mean). In other embodiments, the average may be calculated as the median, mode, geometric mean and/or weighted average. Industry-related data stored on database 315 may include, for example, industry reports relating to sales, in-market data for sampling service providers, as well as legal data relating to any possible restrictions or hindrances regarding the sale of a particular commodity. Market and industry data may be generated by any suitable means, such as imported from external data sources 317 (e.g. market/industry analysis providers), or may be generated through an internal analysis of transaction database 310.

Embodiments of the present disclosure may be used to collect, determine, and deliver information on unregulated utility services via analysis of payment card transaction data. In order to identify relevant transactions payment card transaction data stored in database 310 as well as market and industry data stored in database 315 may be subject to a filtering operation 330 according to the requirements of a particular application in order to selectively identify transactions relating to a commodity of interest. By way of non-limiting example only, the transactions data may be filtered according to different rules or targeting criteria, such as type of utility service provider for targeted analysis. In embodiments, filtering may be aimed at various forms of data, such as merchant ID numbers, card network codes, transaction dates, transaction type codes, user-provided information, and the like. Further filtering (e.g. by geographical location, e.g. region, state, county, city, zip code, street) may be applied to further target particular aspects of the transaction data for given applications. Still further, filtering according to a particular time range (according to need and/or availability, seasonal events, etc.) may be implemented.

Filtered transaction data is provided to one or more processors, embodied in the illustrated system as analytics engine 350, for further refinement. Analytics engine 350 utilizes statistical analyses and techniques applied to the payment card transaction data to analyze the payment card transactions records to determine relationships, patterns, and trends between and among the various transaction records in order to predict future transactions and estimated times and frequencies associated with such transactions. Such statistical analyses may be targeted to particular subsets of the transactions data, including by way of non-limiting example, one or more particular geographic regions, business categories, customer categories, product or service types, and purchasing frequencies. The transaction records may be processed and segmented into various categories in order to determine purchasers of a given unregulated service utility, purchasing frequencies, and drivers or factors affecting purchasing frequency or purchase pricing, by way of non-limiting example. It is to be understood that implementation of the present disclosure is performed without obtaining personally identifiable (private) data such that the results are not personalized. This enables maintaining privacy of a given user's identity unless the user opts-in to making such data available. In some implementations, the user data is anonymized to obscure the user's identify. For example, received information (e.g. user interactions, location, device or user identifiers) can be aggregated or removed/obscured (e.g., replaced with random identifier) so that individually identifying information is anonymized while still maintaining the attributes or characteristics associated with particular information and enabling analysis of said information. Additionally, users can opt-in or opt-out of making data for images associated with the user available to the system.

The analytics engine may utilize independent variables as well as dependent variables representative of one or more purchasing events, customer types or profiles, merchant types or profiles, purchase amounts, and purchasing frequencies, by way of example only. The analytics engine may use models such as regression analysis, correlation, analysis of variances, time series analysis, determination of frequency distributions, segmentation and clustering applied to the transactions data in order to determine and predict the effect particular categories of data have on other categories.

In one embodiment, analytics engine 350 is configured to analyze and ascribe market characteristics associated with a particular type of utility service provider within a particular geographic region (market) according to various statistical processing operations performed on the transactions data. The market characteristics may include overall market data and statistics associated with a given utility service segment, such as data aggregated from payment card transactions from a multiplicity of merchants (e.g. utility service providers), or may more directly target statistics on individual utility providers. Such statistical processing and operations may include, by way of non-limiting example, determining average utility amount, average payment frequency, seasonality of payments, payment trends/dates, and loyalty indices (e.g. timeline of consumer/merchant transactions) associated with one or more merchants/utility service providers. The system is configured to profile and categorize the filtered transaction data according to logical relationships for the purpose of identifying market opportunities. Statistical data on individual utility providers based on the transaction data may be analyzed by analytics engine 350 to provide particular insights for a select application. For example, a given merchant (utility service provider) may obtain competitive insights for a specific market (e.g. geographic region) based on analysis of the payment card transactions data for utilities conducting business within the region, so as to determine comparative pricing among competitors in the market (e.g. utility indexes are 10% higher on average monthly utility bill than direct competition in the New York metropolitan region). Similarly, a given merchant may aggregate customer information based on the payment card transaction data to assess customer spend profiles over time (e.g. merchant A's customers are paying 10% more on average for electricity than last year). Such enhanced information may be useful for applications directed to utility providers that may provide marketing insights to a specific market, to provide a list of customers who may have incentive to switch from their current service provider, or to model a market segmentation strategy for targeting potential “switchers” or profitable new customers based on customer profiles.

Likewise, the system may be configured to provide insights to residential or business utility consumers with regard to particular utilities and utility providers based on analysis of the payment card transactions within a given region, according to particular applications. For example, statistical data on individual utility providers and/or aggregated utility provider profiles based on the transaction data may be analyzed by analytics engine 350 to provide particular insights for a select application. For example, a given consumer may obtain competitive insights for a specific market (e.g. geographic region) based on analysis of the payment card transactions data for utilities conducting business within the region, so as to determine comparative pricing among competitors in the market (e.g. its neighbors are paying 7% less for electricity on average monthly utility bills in the New York metropolitan region). Similarly, a given customer may obtain information based on aggregate merchant data via the payment card transaction data that identifies the number of utility providers (e.g. electric utility providers) servicing the particular region (e.g. determination that 5 electricity providers service customer A's geographic region). Comparison of utility companies in the market based on one or more factors (e.g. average cost, index against the market, loyalty, persistency/volatility in pricing, etc.), may enable customers to obtain more competitive rates that fit their particular profiles, as well as assess potential opportunities and optimal times for switching between utility providers.

Further analytics may include establishing estimated market geographies or boundaries. Establishing market boundaries may be achieved utilizing merchant and/or customer geography groupings that may include city, state or country information. Likewise, standard statistical analysis may be employed, including, for example, clustering, segmentation, raking and the like for estimating market boundaries.

Further still, external data may be used, including Nielsen Designated Market Area (DMA) data, specific market information on utilities, and Metropolitan Statistical Area (MSA). Data may also be analyzed to identify opportunities for marketing, soliciting, and switching utility services within each geographic market. For example, commodity sales data captured in transaction data may be used to estimate demand. Likewise, external data may be used to make an informed assessment of demand. Identified market opportunities, trends, commodity buyers and sellers, and other related data may be stored on a commodity database 360.

The above-described data analysis may be used to guide the generation of logic (e.g. a computer-implemented process or algorithm) for collecting, determining, and delivering information on unregulated utility services. This logic may include sampling techniques, wherein a sample of individuals known to have switched utility providers for “dependent variable” analysis. Sampling may also be used to create profiles of utility service providers and/or customers based on data that may include demographics or spending profiles. Those spending profiles of customers may be constituted from transactions data defined not only from utility transactions records, but transactions associated with other merchants and merchant categories, in order to provide customer profiles that may be based on factors such as one or more of affluence level, gender, age, so as to provide more comprehensive and/or diverse spending profiles of the particular customer. Outputs of the sampling may include logic to identify those utility service providers who have gain/lost customers due to switching and/or acquisition (absent switching) within a given geographic region. This logic may also be stored in database 360 for continued future use.

The above-generated logic may be used to collect, determine, and deliver information on unregulated utility services, including identifying utility service providers, and may attempt to quantify the likelihood that a customer may switch service providers based on payment card transactions data. The output of the applied logic may be in the form of a listing or scored file, with indicators of likelihood to maintain or switch utility service providers, as well as the likelihood of switching to a particular one based on the transactions data.

Further statistical and variable analysis processing via data management processor 370 is utilized in order to ascribe attributes to consumers of a given unregulated utility service. Variables such as geographic area, average utility payment amounts, average utility payment frequency, seasonality of payments, and customer loyalty information may be determined with respect to individual utility providers (merchants), statistical market information relating to customers, as well as more generalized aggregate profiles directed to classes or categories of utility services, merchants, customers, and regions, as well as overall data falling within a particular utility category.

The profiles and attributes from block 370 may be applied to one or more particular customers, merchants or service providers, markets, and other applications in order to provide particular insights for a select application. Such applications include by way of non-limiting example, providing enhanced information for the selection of a utility service provider by a consumer. Additional applications may be directed to utility providers, providing marketing insights to a specific market, to provide a list of customers which may have incentive to switch from their current service provider, or to model a market segmentation strategy for targeting potential “switchers” or profitable new customers.

Each or any combination of the modules and components shown in FIG. 3 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 3, these modules may perform functionality described later herein.

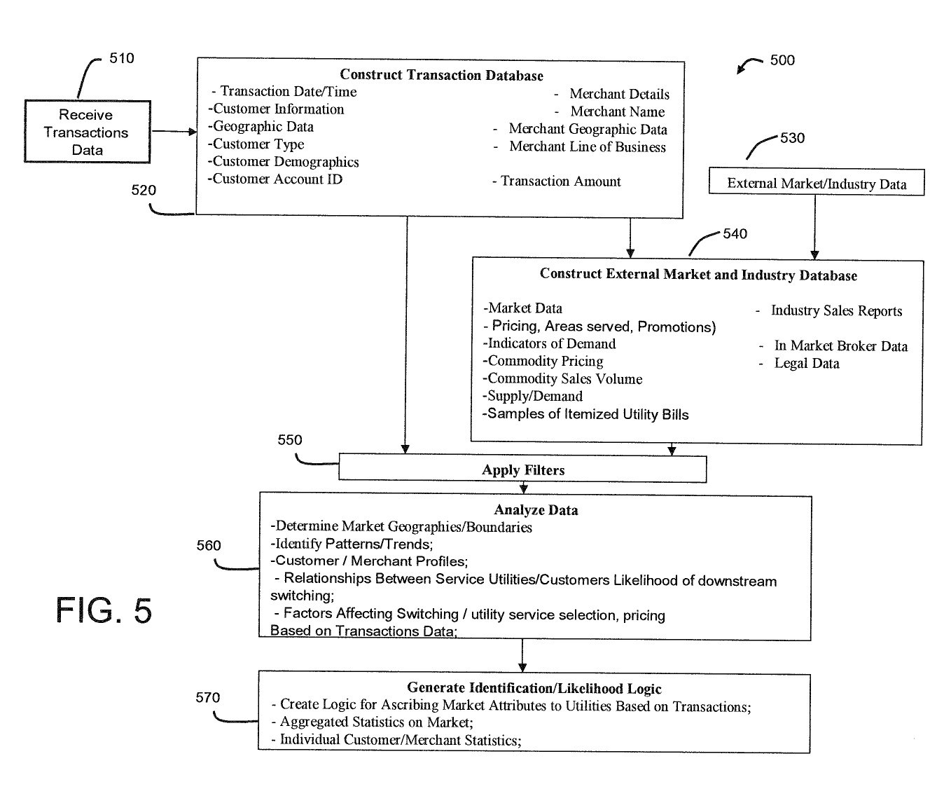

FIG. 5 is a process flow 500 for a system and method for collecting, determining, and delivering information on unregulated utility services via analysis of payment card transaction data. Referring to block 510, payment card transaction data is received by, for example, a card network. From this received transaction data, a transaction database may be constructed (block 520). A transaction database may consist of cardholder transactions, including generalized data, such as date, time and amount, as well as customer and/or merchant information. Customer information may include customer account identifier (possibly anonymized), customer geography (possibly modeled), customer type (business/consumer) and other customer demographics. Merchant information may also be obtained including, but not limited to merchant name, merchant geographical data, line of business, etc.

External market and industry data (block 530) may be obtained from third party providers or independent research, by way of example only. This data may be used to create external market and industry databases in block 540. External market databases may include market data and industrial data. Market data may include indicators of demand, including utilities pricing, sales volume, and an analysis of supply and demand. Industry data may include, for example, industry reports about utilities services and sales, in market data for sampling commodities brokers, as well as legal data relating to any possible restrictions or hindrances regarding the sales of a particular commodity. Samples of itemized or detailed utility bills for various utilities and service providers may be includes, as well as firmographics, market data, pricing and promotions and relevant time periods, example service intervals associated with particular utilities, merchants, and/or geographic regions, and example warrantee periods associated with particular services, merchants, and/or geographic regions, by way of non-limiting example. Such data may operate to link customers and merchants with particular purchases of services within a given transaction. Additional information such as transaction data relating to on-line purchase transactions vs. in-person purchase transactions may also be included.

In block 550 a filtering process may be performed according to the requirements of a particular application in order to selectively identify one or more specific utility providers, classes of utility providers, geographic regions, and the like, for targeted analysis. The filtering process may include temporal filtering which may vary based on need or available data. By way of non-limiting example only, the transactions data may be filtered according to different rules or targeting criteria, such as merchant type or classification (e.g. electricity providers in New York metropolitan area, telephone service providers, cable television providers etc.) for targeted analysis. In another example, filtering of the transactions data may be performed according to a temporal sequencing of transaction events and/or temporal intervals (e.g. last five years' data, seasonal date ranges, product servicing frequency, etc.) as well as by merchant or merchant category. Further filtering (e.g. by geographical location, e.g. region, state, county, city, zip code, street) may be applied to further target particular aspects of the transaction data for given applications.

Referring to block 560, filtered data is subjected to several analytical operations. For example, market geographies or boundaries may be established. Establishing market boundaries may be achieved utilizing merchant geography groupings that may include city, state or country information. Likewise, standard statistical analysis may be employed, including, for example, clustering, segmentation, ranking and the like for estimating market boundaries. Further still, external data may be used, including Nielsen Designated Market Area (DMA) data, specific market information on utilities, and Metropolitan Statistical Area (MSA). Data may also be analyzed to identify opportunities within each geographic market. For example, retail sales data captured in transaction data may be used to estimate demand. Likewise, external data may be used to make an informed assessment of demand.

An analytics engine operates on the transaction data by performing statistical analyses in order to construct logical relationships within and among the transactions records data in order to ascribe attributes and characteristics to the data. Various types of models and applications may be configured and utilized by analytics engine in order to derive information from the transactions data. Such statistical analyses and modeling may include independent and dependent variable analysis techniques, such as regression analysis, correlation, analysis of variance and covariance, discriminant analysis and multivariate analysis techniques, by way of non-limiting example. By way of example only, variables may be defined according to different merchant categories and may have different degrees of correlation or association based on the type or category of merchant (utility). Similarly, different products and/or services of particular merchants may likewise have different degrees of correlation or association. Furthermore, variable analysis of purchasing frequency with respect to particular products and/or merchants may also be utilized as part of the analytical engine in order to determine particular consumers who purchase a given unregulated utility from a given merchant or provider.

Further analytical processing of the transaction data includes performing one or more of variable analysis purchase sequencing, segmentation, clustering, and parameter modeling to establish profiles, trends and other attributes and relationships that link merchants, customers, events and utility services. For example, the analysis engine operates on the transactions records to cluster or group certain sets of objects (information contained in the data records) whereby objects in the same group (called a cluster) express a degree of similarity or affinity to each other over those in other groups (clusters).

Data segmentation of the transactions data associated with the analytics engine includes dividing customer information (e.g. customer IDs) into groups that are similar in specific ways relevant to other variables or parameters such as geographic region, spending amounts, purchase frequency, use of same merchant or utility service provider, customer type (e.g. individual consumer or business), demographics, and so on.

The transactions data may be further analyzed based on purchase sequencing for a particular customer ID in order to determine patterns and/or purchasing behaviors, trends and frequencies of a particular customer or group of customers based on the transactions records in the database.

Through these analytics processes, the transactions data is categorized in as many ways as possible and the analytics engine then determines relevant characteristics associated with categorized transactions data according to particular transactions records of interest and/or filtering information based on a particular application.

Processing continues wherein the categorized transactions data and customer and merchant profiles are processed according to select independent, dependent and/or specialized variables to identify trends, customer behaviors, and relationships between product and service purchases by customers, purchasing frequency intervals relating to particular customers, merchants and/or products and services, and probabilities associated with the likelihood of future customer purchases (or switches to different utility providers) of particular services based on the analysis of the transactions data. Such variables may be derived from particular transaction data or alternatively, used as default variables and updated as part of the analytic engine. Different weighting values or coefficients may be applied to the different variables in order to more finely tune the analysis. For example, more recent transaction data may be weighted more heavily than older transaction data. Likewise, transactions records reflecting services in geographical areas outside of a predetermined area may be weighted less (or more) than those within the area, depending on the application.

This data analysis may be used to guide the generation of logic (block 570) for identifying and ascribing those commodities. This logic may include sampling techniques, wherein a sample analysis is made for the purposes of performing “dependent variable” analysis. Sampling may also be used to create profiles of customers and/or merchants based on data that may include demographics or spending profiles.

Based on the analytical transaction data processing, select attributes are ascribed to customers or purchasers of a serviceable property. Such attributes, preferences, tendencies, correlations and associations are then applied to select transactions data records for particular customers or merchants for the given serviceable product in order to provide information and insight relative to a select application (e.g. specific customer, merchant, service interval, price points, service switch/changeovers).

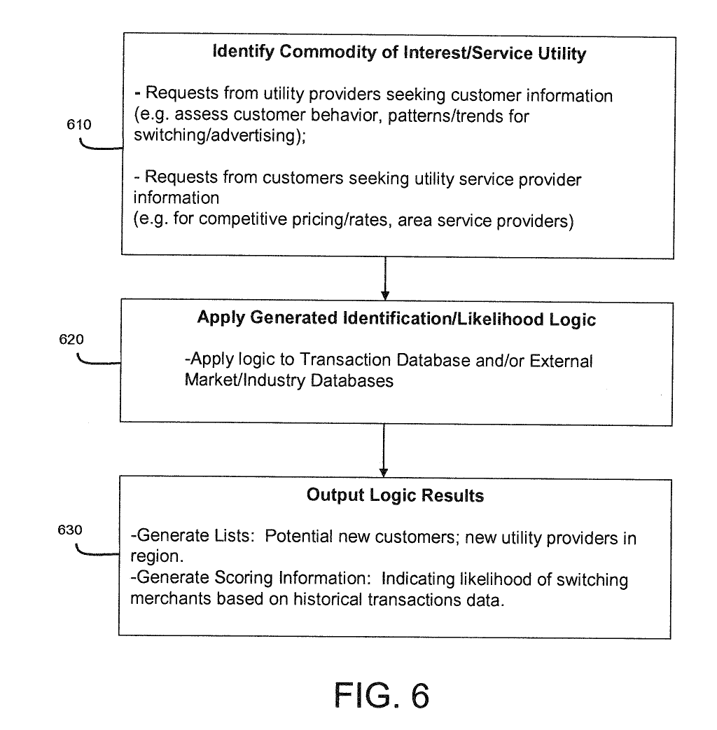

Referring generally to FIG. 6, the above-generated logic may be used in a process 600 for identifying one or more customers of a utility service provider and their likelihood of having a willingness to switch to another provider. In block 610, a service utility of interest is identified. For example, a merchant may enter via a user interface to the managing computer system a request for information regarding consumers/customers/potential customers of a given commodity (utility) within a given geographic region. Alternatively, an inquiry may be made by a customer via an interface to the system seeking potential merchants offering lower pricing for a given utility. In block 620, the above-described generated logic is applied to the commodity database, the transaction database, and/or the market/industry databases. Depending on the request for data, the application of the logic may result in a listing of individuals within a geographical location and their present association with a given utility and/or provider, as well as an indication of their likelihood to switch to a different utility and/or provider. As set forth above, this indicator may be based on, for example, a history of similar sales/transactions, or may take into consideration an offered price vs. average or recent selling prices of similar commodities. Likewise, the application of logic may be used to generate a list of potential commodity buyers at the request of a commodity provider.

### EXAMPLES

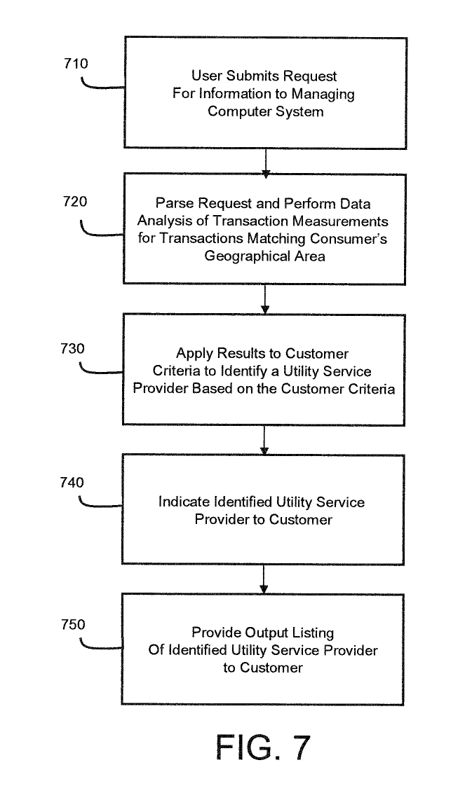

Referring now to FIG. 7, there is illustrated a system and process flow that uses payment card transaction data to determine the pricing employed by deregulated utilities in various geographies. In one embodiment, the system is configured to process historical transactions records to generate profile data for determining relational characteristics and traits in order to identify one or more candidate utility service providers based on a user's selection criteria. This information can be used by consumers looking to identify the best utility provider based on predetermined criteria such as cost, service, longevity, and so on. In an exemplary embodiment, a consumer of an unregulated utility service (e.g. electricity) submits a request 710 (via computer system 121 of FIG. 1) to provide a comparison of costs of all electricity providers servicing the geographical area in which the consumer is located. The request may include but is not limited to information such as geographic region, type of utility (e.g. electricity provider as opposed to natural gas provider, or cable and satellite, telephone service, high speed internet fiber optic or DSL providers, etc.), identifying information of the consumer, and a time period defining a range of historical utility payments for the identified utility type. The consumer request is parsed by a request handler of computer management system 110 (shown in FIG. 1). The criteria in the request is applied to payment card transaction data 310 (FIG. 3) in the database. The process generates a profile listing of electricity providers within the selected geographic region for submission to the consumer. According to an embodiment, this is accomplished for example, by applying in an analytical phase, payment card transaction records corresponding to utility payments from customers to merchants identified as suppliers of the requested utility type (e.g. MCC code=900 (utilities) and further those whose subcategory are “electricity” providers) within a select region (e.g. defined by state, city or zip code). Merchant profiles are generated for the particular utility type based on the transactions data. Further filtering may be performed, for example, to identify those transactions that occurred within a relevant time period (e.g. last 12 months). Payment card transaction numbers, time periods, and amounts per transaction may be aggregated and processed to determine relevant characteristics or traits such as average utility payment amount, average payment frequency, payment seasonality, customer/merchant continuous transaction longevity, number of customers per specific merchant, and the like. Parameters such as geographical location (e.g. state or region) may also be utilized. Segmentation according to different geographic regions enables the system to calculate and compare relative utility prices on a per region basis, as well as perform comparisons of individual merchants (utilities) cost amounts within a given region based on the payment card transactions data.

Based on the computer system's analysis of the transaction data, a profile of potential utility service providers is identified and relayed to the consumer. An additional analysis step is applied to the results based on criteria provided by the consumer 720. For example, the consumer may search for an electricity provider based solely on cost. Data analysis may identify cost factors that are not readily discernable from advertised rate pricing provided by suppliers. Historical payment data and analysis of these transactions may identify additional cost factors, such as introductory rates (e.g. by comparison of average payment amounts over time), activation fees, seasonal demand, or graduated pricing based on usage for the utility and other costs or savings based on in-market transaction data independent of advertised prices. These may be determined by first determining the initial payment card transaction between a given customer and utility merchant, and calculating average amounts paid over a relatively short interval (e.g. the first 3 months of transaction payments) and comparing with the calculated average amounts paid over a relatively longer interval (e.g. first 12 months or more of transaction payments). It is understood that other intervals may be utilized in order to assess and calculate price breaks and introductory rates relative to a much longer term utility pricing.

In another aspect, the consumer may search for a supplier based on reputation or perceived quality of service. Transactional data analysis may indicate trends relating to customer loyalty (e.g. the number of times customers have switched to/from a given utility merchant). Sequential payment analysis may indicate that consumers within a given geographic region and of a given profile (e.g. affluent, middle class, low income, etc.) have shown a migration to a particular utility supplier, indicating market acceptance of the supplier as a reliable or quality provider. Transactional history that shows a consumer switching from supplier A to supplier B, and then switching back to supplier A, may indicate that consumers were less satisfied with the service offered by supplier B, than the services provided by supplier A for example. Based on the data analysis and the consumer criteria, the computer management system 110 (FIG. 3) identifies a utility service provider that best matches the consumer's request based on data analysis of the transaction data and application of the data analysis to the consumer criteria and indicating the identified service provider to the consumer 740. An output listing may be provided 750 to the consumer indicating the results of the data analysis, including a listing of service providers meeting the customer's criteria for selecting a service provider.

By way of non-limiting example, additional information may be included in the output listing provided to the consumer. For example, customer profile data may be generated by the computer system based on aggregate customer event and spending data according to payment card transaction records. A predictive model may be established based on an aggregated spending profile which predicts the general frequency of a periodic utility service (e.g. electric bill, or telephone bill) for a given customer (e.g. customer id) within a given geographic region (e.g. Virginia) using the statistical analysis techniques discussed hereinabove. Predictive models for scoring and rank ordering are known to those of skill in the art and will not be described further for sake of brevity. Market insights may be determined based on the data analysis. For example, generation and analysis of a customer/consumer payment profile (payment amounts, frequencies, etc.) within a given region and utility relative to other similarly located customers may provide information that the customer's neighbors (e.g. other customers in the consumer's geographical area) are paying less (e.g. 10% decrease) for their electricity payment than the consumer is currently paying. The output listing may indicate that consumers who switched from supplier A to supplier B realized a 10% drop in their utility bills, or that Supplier A provides the lowest average rates for consumers meeting the consumer's profile, such as usage patterns (which may be based on prior payments, or may be provided as external data from the consumer showing detailed billing information), location, or available suppliers. The output listing may also provide a comparison of utility providers in the market based on several measures including but not limited to, average cost, index against the market, loyalty and persistency in pricing. Using the information provided in the output listing, the consumer may be able to make an informed decision regarding the selection of a utility (e.g. electricity) service provider.

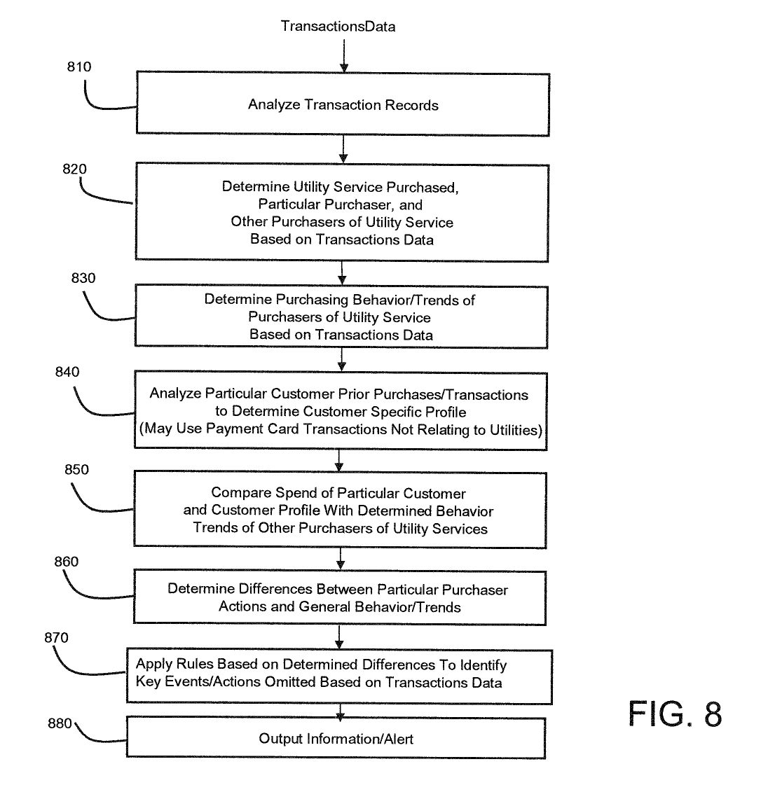

FIG. 8 illustrates an exemplary process flow whereby the system embodied in the present invention performs a transaction analysis 810 of a select customer or merchant of a utility service to determine 820 information concerning the utility service purchased as well as determine other purchasers of that type of serviceable property. Based on analytics processing of the transactions data records as discussed herein, the system determines 830 general trends, tendencies or probabilities of multiple customers purchasing the particular type of utility service. Analysis of the purchasing history and transactions associated with the particular customer purchasing the property identified in block 820 is also performed 840 in order to determine a particular customer profile. Comparison 850 of prior purchases of the select or particular customer (e.g. particular customer profile) with the general purchasing trends and attributes of multiple customers of the particular type of utility determined in block 830 (e.g. aggregated customer profiles) is performed in order to identify differences (block 860) therebetween. In this manner, application of a set of rules (block 870) based on the determined differences between the customer specific profiles and the aggregated profiles for specific events or actions associated with the utility enables direct and immediate identification, communication, and targeting (block 880) of specific actions relevant to the particular serviceable property.

For example, comparison (block 850) of the transaction records of the individual customer profile (block 840) of a particular utility customer with the aggregated customer profiles (block 830) of other utility customers (multiple aggregated profiles) may yield information (block 860) that certain actions typically associated with utility customers have not yet occurred for that individual customer, such as a previous switch from one utility provider to another (e.g. within a given period of time—e.g. last 3 years). A rule (block 870) or series of rules as is understood in knowledge based systems, may be applied to the determined differences (block 860) in order to identify and/or output to a third party information on key distinct events or actions associated with the serviceable property that have not yet occurred for the particular customer based on analysis of the transactions data. Such enhanced information may be important to the requestor (i.e. local utility provider) to enable the requestor to immediately target (block 880) that list of prospective customers that have not made changes to their potential utility providers within a given time interval, and which may be independent of seasonal time interval attributes ascribed.

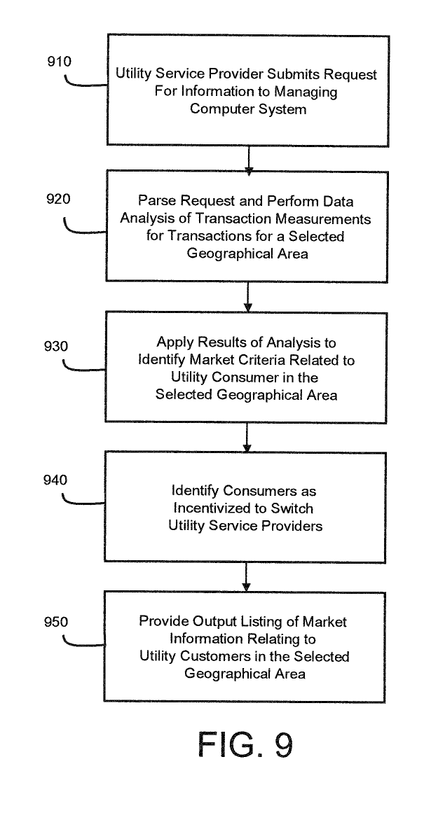

Referring now to FIG. 9 in conjunction with FIGS. 1-8, there is illustrated a system and process flow for obtaining profile data to determine relational characteristics and traits associated with a selected utility market and apply said determined characteristics and traits to determine consumer sentiment or for servicer provider selection based on historical utility payment card transaction data. More particularly, in an exemplary embodiment, a merchant or provider of an unregulated utility (e.g. a telephone company) submits a query 910 requesting information (e.g. via computer system 121 of FIG. 1) concerning utility customers within a given region. For example, a service provider may request a list of utility customers that may likely be willing to switch telephone service providers, or request a list of customers who may be in the market for a new telephone service provider. The query may include information such as a) geographic region (e.g. zip code); b) type of utility (telephone); c) requester (e.g. merchant requesting the information); and d) time period (e.g. telephone utility payments over the last 12 months). The data may further include an event or action to be linked with the selected utility service, such as the number of customers who have switched from one telephone service provider to another telephone service provider within a predetermined interval (e.g. within last 12 months). The query is parsed by a request handler of computer management system 110 (FIG. 3) and the relevant data contained in the query (e.g. geographical location) is applied to the payment card transaction data 310 (FIG. 3) in the database in order to process and generate a profile listing of potential new customers for submission to the query requestor. In an exemplary embodiment, this may be accomplished by applying in an analytical phase those transaction records corresponding to telephone utility payments, and further filtering the data based on temporal aspects that reflect the relevant time periods (e.g. within 1 year) as well as other parameters, such as relevant geographic region (e.g. zip code) 920, and further performing purchase sequencing analysis of the data (e.g. were payments representative of an initial promotional period offered at a reduced rate, with subsequent transactions occurring at higher rates representative of a nominal spend level for that customer; did switching of telephone suppliers by consumers occur). Based on the computer system's analysis of the data, the results of the analysis are applied to identify market criteria relating to utility customers in the region of interest 930. The system is further configured to analyze data for establishing associations and relationships to related actions or event purchases (e.g. consumer loyalty) related to the utility payments (e.g. did a consumer switch from provider A to provider B, only to switch back to provider A?). Database records containing listings of related actions and events relating to the utility payments may be processed and correlated. Based on the correlation, a rules engine identifies consumers which may have incentive based on the market criteria to switch telephone service providers 940. The system may output a listing of information relating to utility customers within the selected geographic region 950, as well as recommended inquiries targeted to consumers for example, in the form of advertisements, for timely submission by the utility service provider to potential new customers. The output listing may include a model, or market segmentation strategy to identify likely switchers or potential new customers. The output listing may include a customer profile providing identifying information for a dataset of consumers for targeted marketing or advertising.

In one embodiment, the system is configured to performing payment sequencing analysis on the payment card transactions to yield data indicating intervals where customers made payments to a specific utility service provider, but later stopped making such payments to the utility service provider, and started to make payments to a different utility service provider of the same type. Such analysis yields an indication of a switch of utility service provider, and may further identify aspects of customer loyalty in the marketplace based on the relative duration and frequency with which payments were made. In an embodiment, the relative frequency (and/or amount) of payment card transactions between a given customer and merchant over a given time interval is analyzed. The system determines based on the payment card transaction data, that a utility provider switch has been made when: a) no payment card transactions between a given utility merchant and historical customer of said merchant have been made within a given threshold interval (e.g. within three months); and b) one or more payment card transactions between said customer and another utility merchant of the same type have begun within said threshold interval. In one variation, the relative amounts of each payment card transaction for a given customer are analyzed to determine changes in payment amounts to a given utility merchant. The system may be configured to analyze relevant changes that may be indicative of a changeover or a partial switch of a utility provider. For example, the system may be configured to analyze the payment card transactions data to determine a switch of a service (e.g. a bundled package of internet, cable, and telephone) from utility merchant 1, to only telephone service carried by utility merchant 1, along with a newly added provider (utility merchant 2) for internet service. In one example, the cable service may be omitted or included as part of the service transacted with utility merchant 2 or with another utility merchant. The system determines a change or partial switch has been made when: a) the average amount of the payment card transactions between the given utility merchant (utility merchant 1) and historical customer have decreased more than a predetermined threshold value over a given time interval (e.g. 20% or more decrease in average payment amounts over the last 6 months); and b) one or more payment card transactions between said customer and another utility merchant (e.g. utility merchant 2) of the same type have begun to be made within said given time interval.

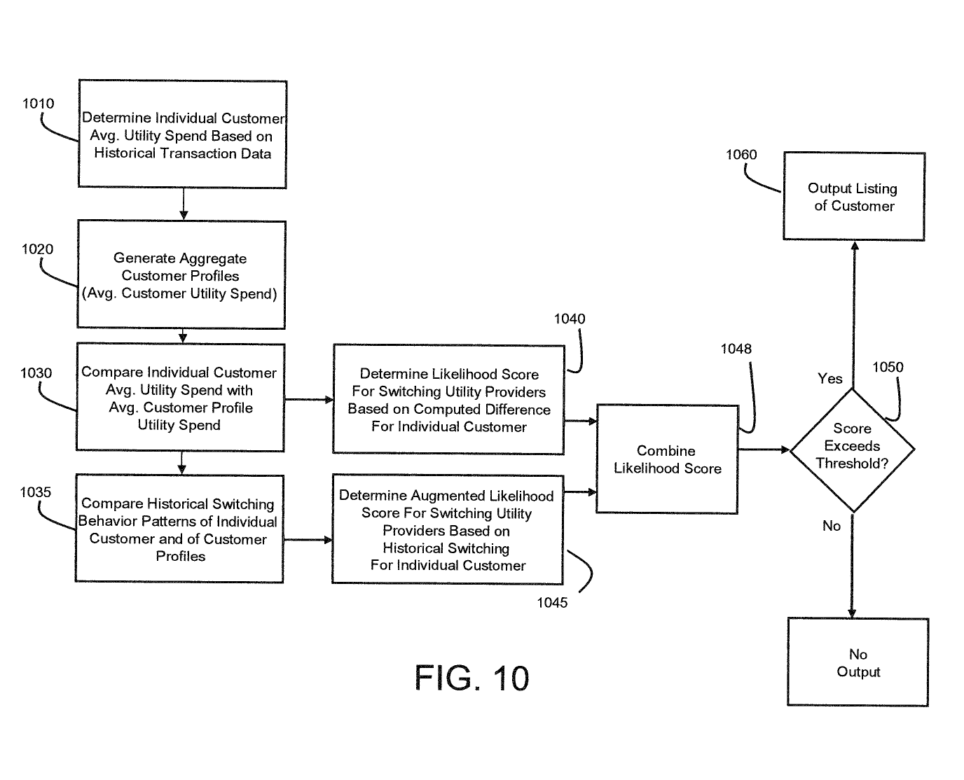

FIG. 10 illustrates an exemplary process flow for determining a likelihood of consumer sentiment for changing servicer provider based on historical utility payment card transaction data. For a given geographical region (e.g. zip code) and select utility (e.g. electricity providers), the system calculates the average electric utility payment price of each customer (block 1010) based on the payment card transactions data history. Customer profiles (block 1020) may be generated and classified based on various factors including the aggregate customer spend (high utility spend customers, mid-level, low utility spend customers), as well as in accordance with the particular merchant providers associated with the corresponding customer. Customer profiles for the utility customers may also be generated based on determined customer attributes such as determined affluence levels. This may be determined by analysis of payment card transactions and merchants in other categories (e.g. jewelry (MCC code=5944) and frequent customer transactions with high end merchants (e.g. Tiffany & Co., Global Gold & Silver, etc.) for large transaction amounts), with customer profiles being generated independent of the utilities transactions. In this manner, a given utility customer may be associated with multiple customer profiles linking the average utility payment price. As shown in block 1030, in one embodiment the system compares the average utility price of a given customer with the average aggregate utility price associated with one or more of their customer profiles to determine whether the given customer is paying more or less than the average aggregate price (calculated difference). If the given customer's average utility cost exceeds that of the profile aggregated average cost, the system computes a probability score or likelihood indicator (block 1040) representative of the likelihood that the customer would switch utility providers based on the calculated difference. The likelihood probability for switching increases/decreases with increased/decreased differential. Thresholds of calculated difference values may be used to generate the probability scores. For example, scores may be incremented from 0 (customer average cost is less than or equal to the profile aggregated average cost) in increments of 0.1 to a maximum (e.g. 1.0) based on the calculated differential. It is understood that other measures and scales may be implemented according to the requirements of a given application. Based on comparison (block 1050) of the probability score with a given threshold (e.g. 0.5), a listing of each of the customers whose probability score exceeds the given threshold are output (block 1060) to the merchant. The system may also analyze attributes such as switching frequency associated with aggregated customer profiles to determine average switching times/longevity periods of customers (block 1035) for comparison with the switching frequency and/or longevity interval of the given customer based on historical payment card transactions data. For example, based on historical analysis of the transaction data for a given customer profile in a particular region, it may be determined that on average customers switch specific utility providers once every three years, with subsequent switching occurring only after at least 6 months service with the present utility provider (e.g. due to introductory rates). By comparing the average aggregate switching frequency and longevity period with the switching history of the particular customer, the system may compute an augmented probability score or likelihood indicator (block 1045) representative of the likelihood that the customer would switch utility providers based on the switching frequency and longevity period. This augmented likelihood probability score may be combined (e.g. added/subtracted) with the results of block 1040 to provide further probability determination (block 1048). Different weighting values or coefficients may be applied to the different variables in order to more finely tune the analysis.

According to another exemplary embodiment, payment card transaction data is analyzed to determine relevant information offerings of one or more unregulated utility providers in a particular region. Utility customers may choose a particular utility service provider for a number of different reasons. Prices fluctuations between suppliers may make a particular supplier appear less expensive than another based only on advertised price rates. Looking at consumer purchase decisions from a longer term viewpoint, there may be providers that offer lock in pricing, or price breaks at certain levels of usage. Furthermore, some consumers may switch providers. Payment card transaction data may be used to determine whether consumers who switched providers wound up paying less overall for their utilities, or whether the switch made no difference or actually increased the overall cost of service. Using the statistical analysis techniques discussed hereinabove with respect to FIG. 3, a consumer may be provided with a basis for selecting a utility service provider who best serves their requirements, identifying the service providers who are competing for business in the consumer's geographical area. For example, the profile attributes ascribed to consumers of electric utilities may depict that the general trend is for a consumer to select a service provider based on advertised prices for electricity (e.g. cost per kilowatt hour). This general trend may be adapted according to customer profile data relating a select customer (i.e. customer specific profile) for the particular utility. Additional relational data events and variable factors (e.g. recent increases in the consumption of electricity due to seasonal variables) may be further applied to adjust the likelihood that a particular customer is incentivized to switch service providers or to establish new or additional service.

In another application, payment card transaction data may be analyzed and used to provide utility service providers a picture of their competitive landscape within a given region, and identify opportunities for entering a given market. Information may include other service providers with which they are competing for customers, economic factors for which they are competing based on consumer sentiment, migration information regarding consumers switching service providers, and customer loyalty information relating to given service providers. These facets of the marketplace may be made available through the statistical analysis techniques discussed hereinabove with respect to FIG. 3.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A system for determining market information of unregulated utility services comprising:
one or more data storage devices containing payment card transaction data of a plurality of customers, the payment card transaction data including at least customer information and information identifying a category of unregulated utility services associated with the transaction data;
a filter configured to identify payment card transactions associated with the category of unregulated utility services from the payment card transaction data within a predetermined geographic region;
one or more data storage devices containing at least one of market and industry data related to the category of unregulated utility services associated with the transaction data;
one or more processors;
a memory in communication with the one or more processors and storing program instructions, the one or more processors operative with the program instructions to:
analyze the identified payment card transactions and the market or industry data related to the category of unregulated utility services to determine a score indicator associated with at least one parameter value representative of a given customer's probability of switching providers within said category of unregulated utility services;
compare the score indicator with a threshold value;
generate an output identifying each given customer whose score indicator exceeds the threshold value.

2. The system of claim 1, wherein the market or industry data includes indicators of utility demand, utility pricing information, and supply estimations.

3. The system of claim 1, wherein the at least one parameter value comprises an average customer spend amount.

4. The system of claim 3, wherein the at least one parameter value further comprises an average customer switching provider frequency.

5. The system of claim 1, wherein the at least one parameter value comprises an average payment frequency.

6. The system of claim 4, wherein the calculation of the probability value includes comparing historical average spend amounts of the given customer with an aggregated customer profile average spend amount from historical averages of multiple customers.

7. The system of claim 6, wherein the calculation of the probability value further includes comparing historical average switching provider frequencies of the given customer with aggregated customer profile average switching provider frequencies from historical averages of multiple customers.

8. The system of claim 1, wherein the unregulated utility services comprises at least one of electric and natural gas suppliers, telephone, cable, satellite, high speed internet, fiber optic and DSL providers.

9. A computer-implemented method for determining market information of unregulated utility services comprising:
generating a database comprising payment card transactions related to unregulated utility services based on processing payment card transaction data of a plurality customers and merchants, the payment card transaction data including at least customer information, geographical information and information identifying a category of unregulated utility services associated with the transaction data;
generating a database comprising at least one of market or industry data related to the category of unregulated utility services associated with the transaction data;
analyzing the payment card transactions and the market or industry data related to the category of unregulated utility services to determine a score indicator associated with at least one parameter value representative of a given customer's probability of switching providers within said category of unregulated utility services;
comparing the score indicator with a threshold value;
generating an output identifying each given customer whose score indicator exceeds the threshold value.

10. The method of claim 9, wherein the market or industry data includes indicators of utility demand, utility pricing information, and supply estimations.

11. The method of claim 9, further comprising the steps of:
determining from the transactions data a historical average customer spend amount for the given customer;
determining from the transactions data an aggregated customer profile average spend amount from historical averages of multiple customers;
determining the probability value by calculating the difference between said historical average spend amounts of the given customer said aggregated customer profile average.

12. The method of claim 11, further comprising the steps of:
determining from the transactions data a historical average customer switching provider frequency for the given customer;
determining from the transactions data aggregated customer profile average switching provider frequencies from historical averages of multiple customers;
comparing historical average switching provider frequencies of the given customer with aggregated customer profile average switching provider frequencies from historical averages of multiple customers to determine the probability value.

13. A system for determining market information for consumers of unregulated utility services based on payment card transaction data, the system comprising:
one or more data storage devices containing payment card transaction data of a plurality customers and merchants, the payment card transaction data including customer information, merchant information, and transaction amounts;
one or more processors;
a memory in communication with the one or more processors and storing program instructions, the one or more processors operative with the program instructions to:
identify consumers of an unregulated utility service based on processing payment card transaction data of a plurality customers and merchants, the payment card transaction data including customer information, merchant information, and transaction amounts, the processing including statistical analysis of said payment card transaction data to identify relationships between different payment card transactions representing a correlation of a given particular service provider linked to said payment card transaction data;
determine, based on said payment card transaction data of the plurality of customers and merchants, characteristic traits of said consumers for actions linked to said unregulated utility service, relating to utility payments for a given action associated with said unregulated utility service, to thereby provide profile data;
select a particular characteristic trait identifiable from said payment card transaction data, and apply to it the determined profile data, along with one or more user selected data characteristics associated with a given action of said unregulated utility service, to thereby obtain data representative of market conditions for the given action of the unregulated utility service adjusted by said user selected data characteristics.

14. The system of claim 13, wherein the one or more processors is operative to output an indication of a likelihood for the given action of the unregulated utility service.

15. The system of claim 13, wherein the statistical analysis of said payment card transaction data comprises at least one of i) a trend analysis, (ii) a time series analysis, (iii) a regression analysis, (iv) a frequency distribution analysis, (v) and predictive modeling.

16. The system of claim 13, wherein the profile data includes one or more customer profiles, merchant profiles, and transaction profiles.

17. The system of claim 13, wherein the given action of the unregulated utility service comprises a switching of service providers for a given customer.

18. The system of claim 13, wherein the unregulated utility services comprises at least one of electric and natural gas suppliers, telephone, cable, satellite, high speed internet, fiber optic and DSL providers.
